(19) United States
(12) Patent Application Publication
(10) Pub. No.: US 2025/0264052 A1
(43) Pub. Date: Aug. 21, 2025

(54) MODULAR ENCLOSURE SYSTEM FOR INDUSTRIAL GENERATOR SETS

(71) Applicant: AVL Manufacturing Inc., Hamilton (CA)

(72) Inventor: Vince DiCristofaro, Burlington (CA)

(21) Appl. No.: 18/939,068

(22) Filed: Nov. 6, 2024

Related U.S. Application Data
(60) Provisional application No. 63/554,731, filed on Feb. 16, 2024.

(51) Int. Cl. F02B 63/04; F02B 77/13

(52) U.S. Cl. CPC F02B 63/044; F02B 77/13; F02B 2063/045

(57) ABSTRACT

A modular enclosure system for industrial generator sets, which provides for a stacked arrangement of MegaWatt gas or diesel generators. A double-stack enclosure system comprises a first enclosure housing a first generator, a second enclosure housing a second generator, and a stacking superstructure. The stacking superstructure is supported by the first enclosure and the second enclosure is supported on the stacking superstructure. Each generator enclosure is modular, comprising a base, a skeletal frame, removable modular wall panels, and removable roof structure, which are attached externally to the skeletal frame. Removable end wall panels comprise sound attenuation boxes. The stacking superstructure has a skeletal frame that provides space for equipment, including an exhaust system for the first generator, and optional other equipment. Each generator is operated and exhausted independently. Removable wall and roof panels, and/or a removable rail mounting system, facilitate access to and removal of equipment for maintenance or swap-out.

### CROSS-REFERENCE TO RELATED APPLICATION

This application claims priority from U.S. provisional patent application No. 63/554,731, filed Feb. 16, 2024, entitled “Modular Enclosure System for Industrial Generator Sets”, which is incorporated herein in its entirety.

### TECHNICAL FIELD

This invention relates to enclosure systems for industrial generator sets, for standby power or prime power applications.

### BACKGROUND

Containerized generator sets (gensets) for industrial applications may be used for standby power or prime power applications. For example, data centers, hospitals, airports, manufacturing plants, et al. may require generators capable of providing MegaWatts (MW) of electrical power for uninterruptible power in the event of a power grid failure. Off-grid, remote locations may require MW generators for prime power source applications. MW generators, powered by natural gas or diesel, may be containerized for a fixed installation, or trailer mounted for mobile systems.

Containers may be based on ISO shipping containers, e.g. 40 foot high-cube containers, or they may be fully custom enclosures. Enclosures may be customized to provide weatherproof protection, even in harsh environments. Enclosures may be sized to house the generator and associated switch gear, control systems, cooling equipment and noise abatement (acoustic insulation). The enclosure may be integrated with a fuel system and exhaust system. Walk-in enclosures include additional equipment to comply with applicable workplace safety standards.

In some scenarios, to provide redundant standby power in event of generator failure or during maintenance, two or more generator systems may be mounted side-by-side. Multiple generator systems may be needed for higher power applications. Dual generator installations or multi-generator installations arranged side-by-side require significant real-estate. Multi-generator installations may share some of the operating components to reduce cost and save space; this can be an issue in the event of failure or maintenance of a shared component, which would require all generators to be shut-down.

Alternative solutions are needed to overcome one or more of these issues.

### SUMMARY OF INVENTION

The present invention seeks to provide an improved or alternative enclosure system for industrial generator sets.

Aspects of the invention provide a modular enclosure system for industrial generator sets, which allows for a double-stack or multi-stack arrangement.

One aspect provides a modular enclosure system for industrial generator sets comprising:
a first enclosure for a first generator set;
a second enclosure for a second generator set;
a stacking superstructure;
the stacking superstructure being supported on the first enclosure and the second enclosure being supported on the stacking superstructure; and
the stacking superstructure providing separation between the first and second enclosure frames comprising space for access and equipment.

For example, a modular enclosure system for industrial generator sets comprises a double stack skeletal frame with a stacking superstructure between upper and lower generator enclosure frames.

Another aspect provides a modular enclosure system for industrial generator sets comprising:
a first enclosure comprising a first skeletal frame for a first generator set;
a second enclosure comprising a second skeletal frame for a second generator set;
a stacking superstructure;
the stacking superstructure being supported on the first skeletal frame and the second skeletal frame being supported on the stacking superstructure;
the stacking superstructure having a skeletal frame providing vertical separation between the first and second enclosures comprising space for access and equipment.

The space between the first (lower) enclosure and second (upper) enclosure accommodates an exhaust system of the lower generator, which allows for lateral routing of an exhaust pipe. This configuration avoids routing of the exhaust pipe of the lower generator up through the second (upper) enclosure frame, and assists with thermal management (reduces overheating). The stacking superstructure provides room for other equipment, e.g. a fuel tank for the upper unit, or switch gear. This space also provides sufficient height for walk-in access for maintenance of the equipment.

For example, part of the skeletal stacking superstructure is unenclosed to provide space for an exhaust system of the first generator set. Another part of the skeletal stacking superstructure may be enclosed by modular sidewall panels, e.g. to provide an equipment enclosure.

In some embodiments each generator enclosure is modular, comprising a base, a skeletal frame, removable modular wall panels, and a removable roof structure; the skeletal frame is supported by the base; the wall panels and roof structure are attached externally to the skeletal frame. One or more of the wall panels may comprise sound attenuation boxes.

For example: the first enclosure is modular comprising a base, supporting a first skeletal frame, and modular sidewall panels are removably attached to side supports of the first skeletal frame, end panels comprising sound attenuation boxes are removably attached to end supports of the first skeletal frame, and a first roof assembly is supported by the first skeletal frame; and
the second enclosure is modular comprising a base, supporting a second skeletal frame, and modular sidewall panels are removably attached to side supports of the second skeletal frame, end panels comprising sound attenuation boxes are removably attached to end supports of the second skeletal frame; and a second roof assembly is supported by the second skeletal frame.

The removable sidewall panels and endwall panels are mounted externally, e.g., attached to external surfaces of the first and second skeletal frames. At least one of the removable sidewall panels of each enclosure comprises an access door. The sidewall panels and endwall panels are removably secured to external surfaces of the first and second skeletal frame by releasable fasteners, such as bolts or latches.

The removable sidewall panels may be provided with various thicknesses, and may comprise at least one of thermal insulation and acoustic insulation.

In some embodiments, the first and second enclosures are configured for longitudinal airflow from an air intake through a sound attenuation box at one end of the enclosure and an air discharge through a sound attenuation box at an opposite end, and a discharge tower is provided for receiving said air discharge.

The base of each of the first and second enclosures comprises mounting pads for the respective generator set.

Yet another aspect provides a modular enclosure system for industrial generators comprising:
a first enclosure comprising a first skeletal frame housing a first generator set;
a second enclosure comprising a second skeletal frame housing a second generator set;
a stacking superstructure;
the stacking superstructure being supported on the first skeletal frame and the second skeletal frame being supported on the stacking superstructure;
the stacking superstructure providing space between the first and second skeletal frames for access and equipment;
a first exhaust system of the first generator set being mounted on the first enclosure in said space provided by the stacking superstructure; and
a second exhaust system of the second generator set being mounted on the second enclosure.

For example, the exhaust pipe of the first exhaust system is routed longitudinally, along a length, through the stacking superstructure.

Part of the stacking superstructure is unenclosed to provide space accommodating the exhaust system of the first generator set which allows for its exhaust pipe to be routed longitudinally.

Another part of the stacking superstructure may be enclosed by modular sidewall panels to provide an equipment enclosure.

The first and second exhaust systems may comprise any one of a Selective Catalytic Reduction (SCR) system, a muffler, or another type of exhaust treatment system or exhaust filtration system.

The exhaust pipes from the first and second exhaust systems may be routed into and through a discharge tower, and vented at an appropriate height into the atmosphere.

In some embodiments, the first enclosure is modular comprising a base, supporting the first skeletal frame, and modular sidewall panels removably attached to side supports of the first skeletal frame, end panels comprising sound attenuation boxes removably attached to end supports of the first skeletal frame, and a roof assembly supported by the first skeletal frame; and
the second enclosure is modular comprising a base, supporting the second skeletal frame, and modular sidewall panels removably attached to side supports of the second skeletal frame, end panels comprising sound attenuation boxes removably attached to end supports of the second skeletal frame; and a roof assembly supported by the second skeletal frame.

The removable sidewall panels and endwall panels are attached externally to the first and second skeletal frame. For example, the removable sidewall panels and endwall panels are removably secured to external surfaces of the first and second skeletal frame by releasable fasteners, such as bolts or latches. The removable sidewall panels may comprise at least one of thermal insulation and acoustic insulation. For walk-in enclosures, at least one of the removable sidewall panels of each enclosure comprises a walk-in access door. Staircases and walkways may be provided for access to each access door.

The base of each of the first and second enclosures comprises mounting pads, the respective generator set being mounted on the mounting pads, and secured thereto.

The roof assembly of the second (upper) enclosure may be removable for installation or removal of the second generator set by lifting.

The base of the first enclosure may be mounted on a base fuel tank.

When part of the stacking superstructure is enclosed by modular sidewall panels to provide an equipment enclosure, equipment such as switch gear of the second generator set may be enclosed within said equipment enclosure, or a day tank to supply fuel to the upper generator may be contained within the equipment enclosure.

For walk-in enclosures, access doors to the first and second enclosures, and staircases may be provided for accessing the access doors of the first and second enclosures and the space in the stacking superstructure between the first and second skeletal frames.

For example, the first enclosure is sized to accommodate the first generator with associated switch gear; and the second enclosure is sized to accommodate the second generator with associated switch gear. A fuel system including a fuel storage tank may be integrated with the modular enclosure system or provided separately.

In some embodiments, the first and second enclosures are configured for longitudinal

airflow from an air intake through a sound attenuation box at one end of the enclosure and an air discharge through a sound attenuation box at an opposite end of the enclosure. The enclosure system may comprise a discharge tower for receiving said air discharge from the first and second enclosures, and venting said air discharge at a top of the discharge tower. Exhaust pipes from each of the first and second exhaust systems are routed longitudinally into and through the discharge tower and vent at the top of the discharge tower.

In some embodiments, the base of the first enclosure comprises means for accepting a removable rail system for mounting of the first generator set, for slidable installation or removal of the first generator set after removing an end panel. In some embodiments, the base of the second enclosure comprises means for accepting a rail system for mounting of the second generator set, for slidable installation or removal of the second generator set after removing an end panel. For example, the rail system comprises mounting means such as slots, recesses or other rail mountings in the enclosure base for receiving removable rails. For example, the rail units are modular lengths of rail, and a pair of slots is provided in the base to receive a pair of rails comprising the modular lengths of rail. The removable rail system comprises a rail extension and support module that extends beyond the end of the first enclosure, the rail extension and support module having a length that accommodates the first generator outside the first enclosure. In use of the rails, the generator is supported on wheels or other rolling means so it can be moved along the rails, for installation or removal.

A further aspect provides an enclosure for an industrial generator set having a modular construction comprising a base, a skeletal frame, removable modular wall panels and a removable roof structure, wherein the skeletal frame is supported by the base and the removable modular wall panels and removable roof structure are mounted externally to the skeletal frame. For example, the skeletal frame comprises a plurality of side support members and end support members, and the removable modular wall panels comprise sidewall panels attached to side support members and end panels attached to the end support members, wherein the end panels comprise sound attenuation boxes removably attached to the end support members.

Yet a further aspect provides an enclosure for an industrial generator set having a modular construction comprising a base, a skeletal frame, modular wall panels and a roof structure, wherein the skeletal frame is supported by the base and the modular wall panels are attached to the skeletal frame, the modular wall panels comprising removable end panels comprising sound attenuation boxes which are removably attached to end support members of the skeletal frame, and the base of the enclosure comprising mounting means, such as recesses or slots, for receiving a removable rail system which is configured to slideably remove or install the generator set from an end of the enclosure after removing one of the removable end panels.

The foregoing and other features, aspects and advantages will be more apparent from the following detailed description, taken in conjunction with the accompanying drawings, of example embodiments, which description is by way of example only.

### BRIEF DESCRIPTION OF THE DRAWINGS

FIG. 1 is a schematic view of an example 2MW diesel generator;

FIG. 2 is a schematic view of an example 2MW diesel generator mounted inside a custom enclosure;

FIG. 3 is a schematic view of an example industrial generator set housed in a custom enclosure;

FIG. 4 is a schematic view of an example side-by-side installation of multiple generator enclosures;

FIG. 5 shows a simplified schematic side view of components of a stacked modular enclosure system of example embodiments comprising first and second enclosures and a stacking superstructure between the first and second enclosures;

FIG. 6 shows a simplified schematic side view of a modular enclosure for an industrial generator set of a first embodiment, with sidewall panels removed;

FIG. 7 shows a simplified schematic side view of the modular enclosure for an industrial generator set of the first embodiment with sidewall panels installed;

FIG. 8 is a schematic side view of components a modular enclosure system of a second example embodiment for double stacking of generator sets, comprising first and second modular enclosures and a stacking superstructure between the first and second enclosures;

FIG. 9 is a schematic isometric view of the modular enclosure system of FIG. 8 in which the exhaust system of the first generator set is omitted to show the frame structure of the stacking superstructure between the first and second enclosures, and some of the sidewall panels are omitted to show the frame structure of the first and second enclosures;

FIG. 10 is a schematic view showing an enlarged view of part of the structure shown in FIG. 9 to illustrate the frame structure of the modular enclosure comprising removable exterior wall panels;

FIG. 11 is a schematic side view of the modular enclosure system of FIG. 8 with some of the wall panels removed;

FIG. 12A and FIG. 12B, respectively, show a simplified schematic side view and a simplified schematic end view of the skeletal frame structure only;

FIG. 13 is a schematic view showing disassembled components of a modular enclosure of a third embodiment;

FIG. 14 is a schematic view of a modular enclosure of a fourth embodiment, wherein the enclosure roof assembly is removable;

FIG. 15 is a schematic side view of a double stack modular enclosure system of a fifth embodiment wherein the generator is mounted on a rail system to enable the generator to be removed and replaced for service or swap-out; and

FIG. 16 is a schematic isometric view a modular enclosure system of the fifth embodiment wherein the generator is mounted on a rail system to enable the generator to be removed and replaced for service or swap-out;

FIG. 17 shows an isometric view of a rail unit for the rail system illustrated in FIG. 15 and FIG. 16; and

FIG. 18 is a schematic isometric view of part of the modular enclosure system of FIG. 16, wherein the generator is supported on part of the rail system extending from the enclosure.

### DETAILED DESCRIPTION

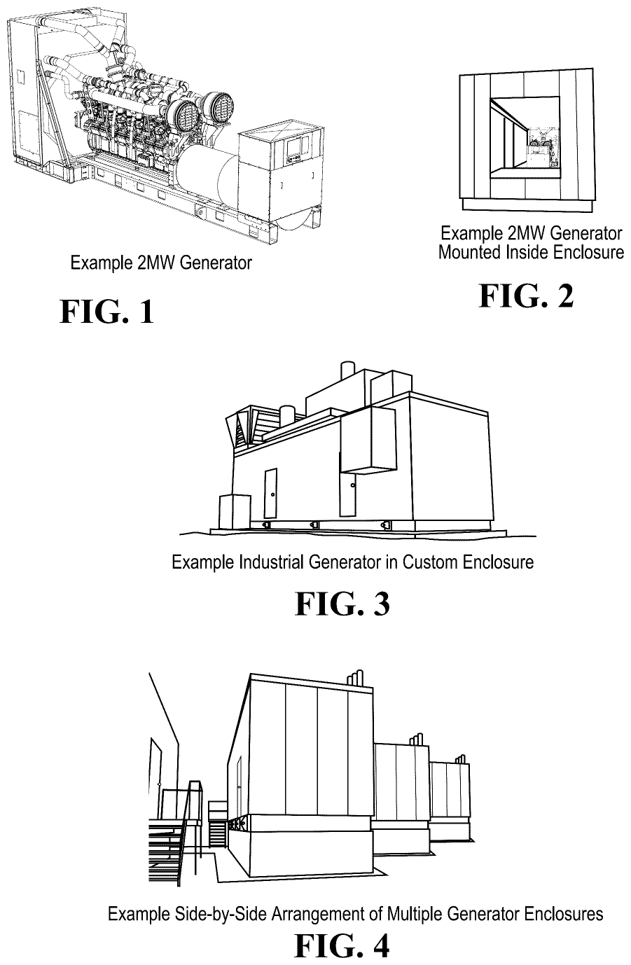

FIG. 1 is a schematic view of an example 2MW diesel generator, and FIG. 2 shows a schematic view of an example of 2MW diesel generator mounted inside a custom enclosure, to illustrate the size of the generator. For example, a 2MW generator may be 3 m high, 3 m wide and 4 m long. As shown, the enclosure is sized to accommodate the generator and associated equipment, with an opening at one end for intake air flow, and side access doors for service technicians.

FIG. 3 is a schematic view of an example generator set housed in a custom enclosure for a fixed deployment. There is a side air intake and a roof mounted air discharge. An exhaust system is mounted on the roof.

FIG. 4 is a schematic view of an example side-by-side installation of multiple generator enclosures at a data centre, to illustrate that significant real estate is required for this type of multi-generator installation.

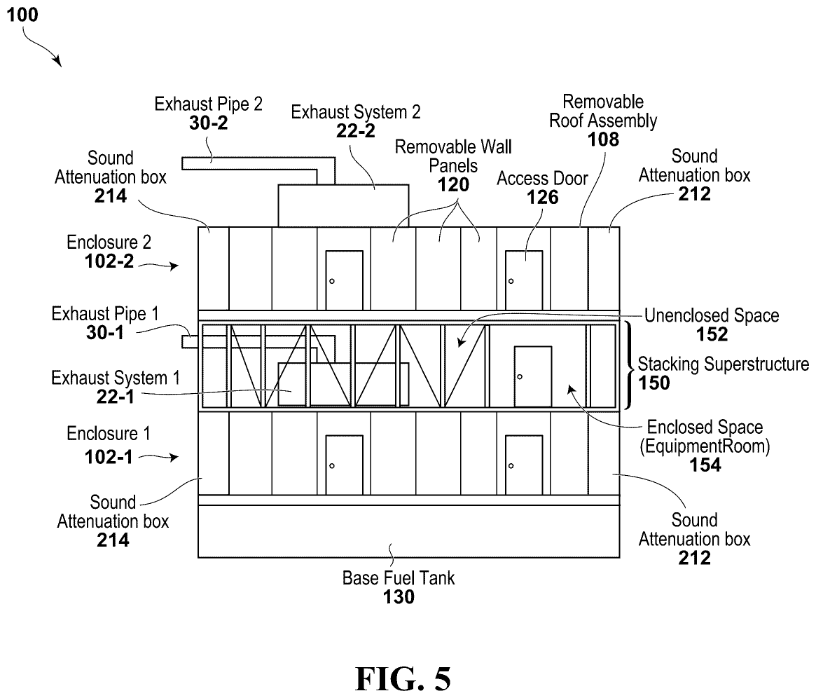

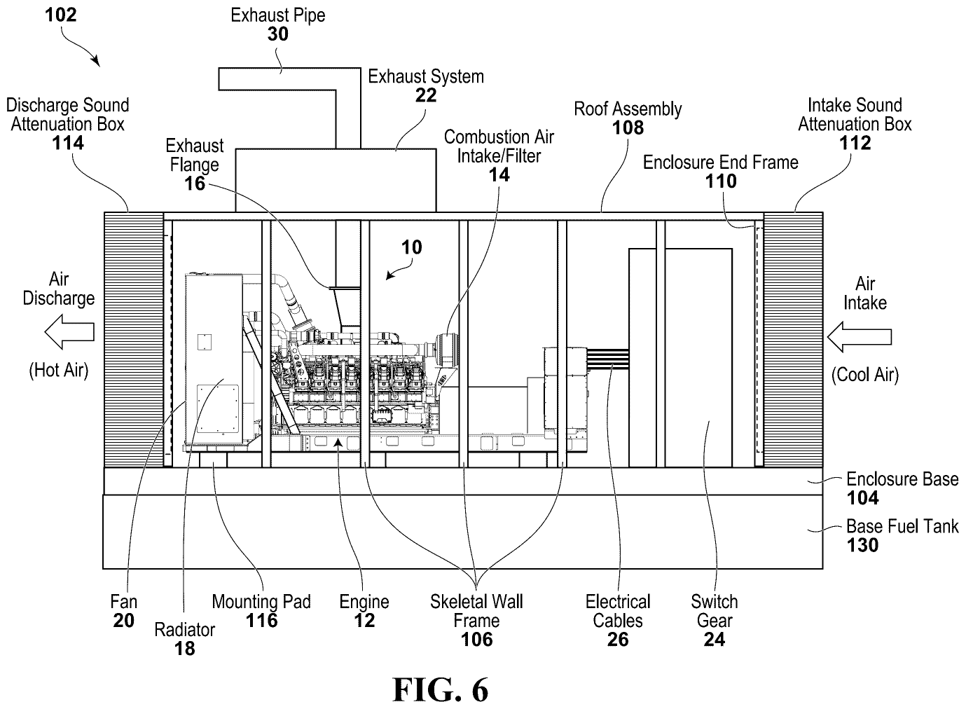

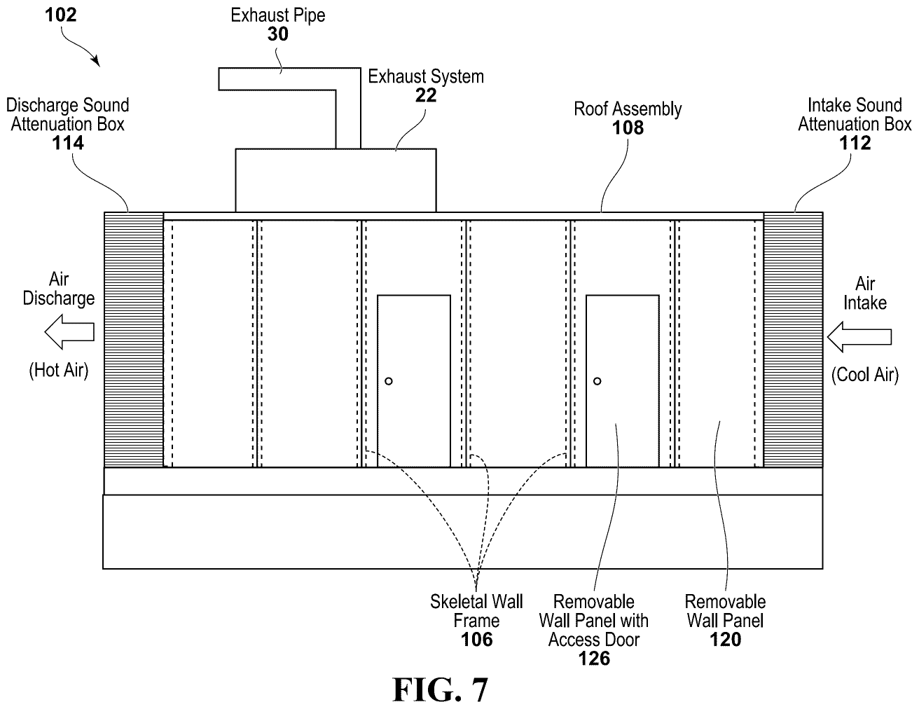

FIG. 5 shows a simplified schematic side view of a modular enclosure system 100 of a first example embodiment comprising a first enclosure 102-1, a second enclosure 102-2 and a stacking superstructure 150 between the first and second enclosures. For example, each of the first (lower) enclosure 102-1 and the second (upper) enclosure 102-2 comprise modular enclosures housing an industrial generator set. In the double stack modular enclosure system of this embodiment, the first (lower) enclosure 102-1 is mounted on a base fuel tank 130, which stores fuel for both the upper and lower generator sets. The skeletal frame of the lower enclosure is engineered to support the stacking superstructure 150 and the upper enclosure 102-2. The stacking superstructure 150 comprises a skeletal frame which provides an unenclosed space 152 between the lower enclosure 102-1 and upper enclosure 102-2, which accommodates the exhaust system 22-1 of the generator housed in the lower enclosure 102-1. The stacking superstructure may include an enclosed space 154, to be used as an equipment room to house equipment, such as switch gear, or a day fuel tank to feed fuel to the upper generator set. The exhaust systems 22-1 and 22-2 may comprise a Selective Catalytic Reduction (SCR) system, another type of exhaust filtration or treatment system, or simply a muffler (silencer), depending on local environmental air quality requirements. The space 152 provided by the stacking superstructure allows for the exhaust pipe 30-1 from the lower generator to be routed laterally, e.g. longitudinally through the stacking superstructure 150. This arrangement avoids routing of the exhaust pipe 30-1 up through the upper enclosure 102-2. The modular skeletal frame construction allows for a double-stack configuration in which each of the lower and upper generator sets has a separate exhaust system, so that the two generators can be operated independently, and separately shut down for maintenance or overhaul. Each of the enclosures 102-1 and 102-2 may have a skeletal frame structure, with removable side wall panels 120, and removable end panels which comprise intake sound attenuation boxes 212 and discharge sound attenuation boxes 214. One or more of the wall panels may comprises an access door 126. To access the upper generator for overhaul or swap out, the roof assembly 108 of the second enclosure is removable. The lower generator may be accessed by removing the end panel comprising sound attenuation box 212. These features are described in more detail with reference to FIG. 6 and FIG. 7

FIG. 6 shows a simplified schematic side view of a modular enclosure 102 for an industrial generator set of a first example embodiment, with sidewall panels removed. FIG. 7 shows a simplified schematic side view of the modular enclosure 102 of the first example embodiment, with sidewall panels installed. Referring to FIG. 6, the generator 10 comprises an engine 12 and associated components, which are mounted in the modular enclosure 102. The enclosure 102 comprises an enclosure base 104, which supports a skeletal wall frame comprising a plurality of vertical supports 106, and a roof assembly 108. In this example, the enclosure base 104 is mounted on a base fuel tank 130. In use, the enclosure comprises side wall panels 120 (not shown in FIG. 6), which are removably attached to the exterior of the skeletal wall frame 106, as shown in FIG. 7. The enclosure end frames 110 are open for airflow and covered by removable end panels comprising sound attenuation boxes 112 and 114 for the air intake and air discharge, respectively. The generator set 10 is mounted on mounting pads 116 on the base 104. The air intake, through intake sound attenuation box 112, is for cooling air and combustion air. Combustion air is drawn into the engine through the combustion air intake and filter 14. Cooling air flow is drawn through the radiator 18 by the fan 20 and discharged through the discharge sound attenuation box 114. The direction of airflow, longitudinally through the enclosure, is indicated by the large arrows. The exhaust flange 16 of the engine 12 is connected to an exhaust system 22 mounted on the roof 108 of the enclosure 102. The exhaust system 22 may be a simple muffler, or if required to meet local air quality requirements, an exhaust treatment or filtration system, such as a Selective Catalytic Reduction (SCR) unit which removes NOx. As illustrated in FIG. 6, the enclosure 102 includes space for the generator 10 and associated switch gear 24 and electrical cabling 26.

As illustrated in FIG. 7, which shows sidewall panels 120 installed, the side wall panels are removably attached externally to vertical supports of the skeletal wall frame, e.g. using bolts, latches or other releasable fasteners. For a walk-in enclosure, one or more of the side wall panels include an access door 126, to provide access for service technicians. For compliance with occupational health and safety regulations (e.g. OHSA), walk-in enclosures must meet various safety requirements, e.g.: clearance requirements; avoidance of trip hazards; electrical safety requirements (e.g. include an NGR (Neutral Ground Resistor)); provide separation between the fuel tank and electrical switch gear to reduce fire risk; and fire suppression components.

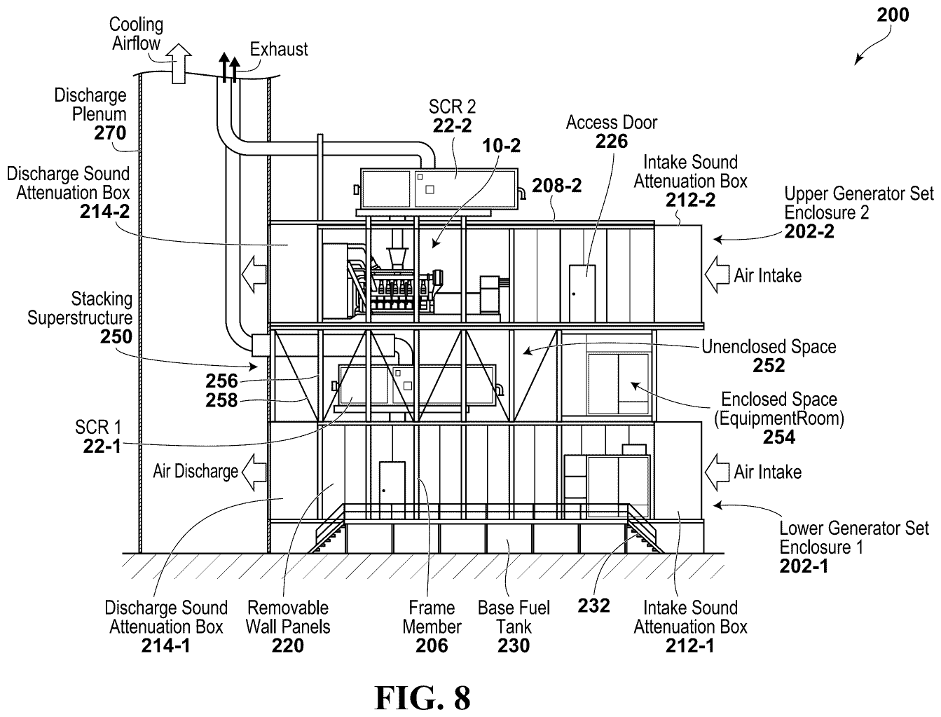

FIG. 8 is a schematic side view of a components a stacked modular enclosure system 200 of a second example embodiment comprising a first modular enclosure 202-1 containing a first generator set and a second modular enclosure 202-1 containing a second generator set, and a stacking superstructure 250. This is a double-stack arrangement comprising a first (lower) generator set and a second (upper) generator set. The first modular enclosure 202-1 is mounted on a base fuel tank 230. The stacking superstructure 250 is mounted on the first modular enclosure 202-1, and the second modular enclosure 202-2 is mounted on the stacking superstructure 250. Each of the first modular enclosure 202-1, and the second modular enclosure 202-2 comprises a skeletal frame comprising vertical support members 206 and modular wall panels 220. The skeletal frame of the first modular enclosure 202-1 is engineered to support the stacking superstructure 250 and the second modular enclosure 202-2. The stacking superstructure 250 supports the second modular enclosure 202-2. The stacking superstructure 250 provides a space between the first and second modular enclosures to accommodate an exhaust system 22-1 of the first generator set, which is mounted on the roof 208-1 of the first enclosure 202-1. Part of the stacking structure which accommodates the exhaust system 22-1 is an unenclosed space 252, and the exhaust pipe 30-1 is routed longitudinally through the stacking superstructure 250, into and through a discharge plenum (discharge tower) 270 to direct the exhaust upwards to be vented at the top of the plenum at an appropriate height in the atmosphere. The exhaust system 22-2 for the second (upper) generator set is mounted on the roof 208-2 of the second modular enclosure 202-2, and the exhaust pipe 30-2 is directed longitudinally into and through the discharge plenum 270, and vented at the top of the plenum.

The stacking superstructure includes an enclosed space 254, which provides an equipment room to house equipment such as switch gear for the upper generator, or a day fuel tank to feed fuel pumped from the base fuel tank 230 to the upper generator.

The stacking superstructure 250 provides for each of the upper and lower gensets to have separate exhaust systems 22-1 and 22-2. The unenclosed space 252 provided by the stacking superstructure allows for the exhaust pipe 30-1 from the lower generator to be routed laterally through the stacking superstructure 250, which avoids routing the exhaust from the lower generator through the upper generator enclosure. The exhaust systems 22-1 and 22-2 may comprise a SCR, or simply a muffler (silencer) depending on local environmental air quality requirements. The modular skeletal frame construction allows for a double stack configuration in which each of the lower and upper generators has its own exhaust system, so that the generators can be operated independently, and separately shut down for maintenance or swap-out.

The first modular enclosure 202-1 comprises a removable intake sound attenuation box 212-1 and a removable discharge sound attenuation box 214-1 mounted on respective enclosure end frames; and the second modular enclosure 202-2 comprises a removable intake sound attenuation box 212-2 and a removable discharge sound attenuation box 214-2 mounted on respective enclosure end frames. Cooling and combustion air is drawn in through the intake sound attenuation box and cooling air is discharged through the discharge sound attenuation box into the discharge plenum, as indicated by the large white arrows. Some of the upper wall panels are shown as transparent (omitted) to show the positioning of the second (upper) generator 10-2 within the upper enclosure 202-2.

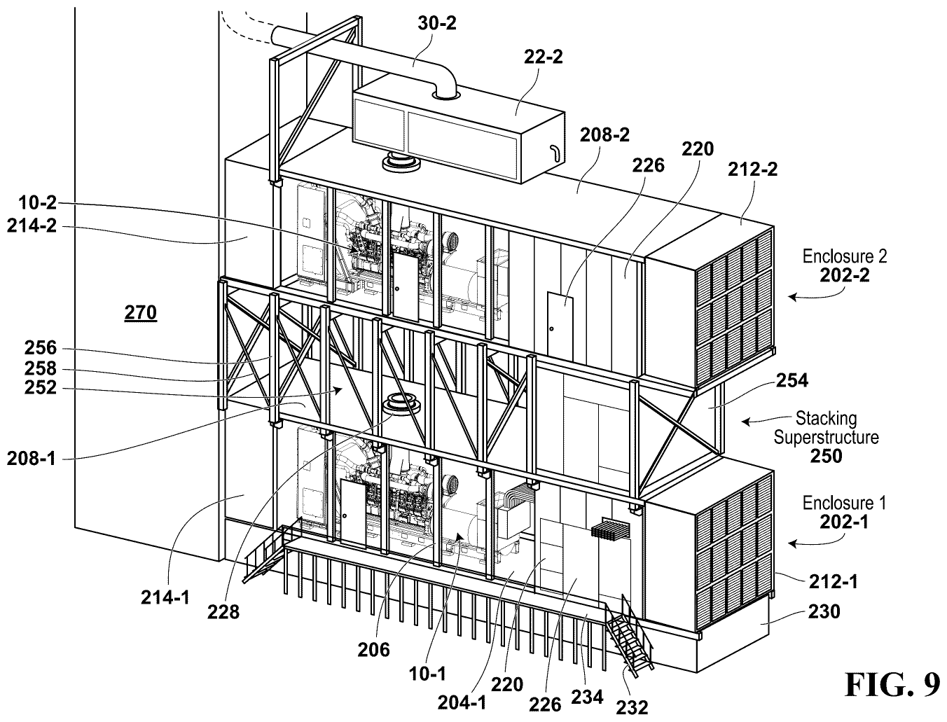

FIG. 9 is a schematic isometric view of the modular enclosure system of FIG. 8, in which the exhaust system of the lower genset is omitted, to show the frame structure of the stacking superstructure 250 between upper and lower genset enclosures 202-1 and 202-2. Some of the removable sidewall panels are omitted to show the frame structure of the upper and lower genset enclosures 202-1 and 202-2. The stacking superstructure 250 has a skeletal frame structure comprising a plurality of vertical support members 256 and cross-bracing members 258. The space 252 within the stacking superstructure 250 for the lower exhaust system is unenclosed to provide for mounting of the lower exhaust system on the roof 208-1 of the lower enclosure 202-1. Since the lower exhaust system is omitted in this view, the exhaust port 228 in the roof 208-1 is visible. Another part of the space within the stacking superstructure 250 is enclosed by modular wall panels to form an enclosed space 254, e.g. an equipment room. For example, this enclosed space 254 may be used for equipment such as switch gear for the upper generator set, or for a day tank to feed fuel from the base fuel tank to the upper generator. Other parts are labelled with the same reference numerals as shown in FIG. 8.

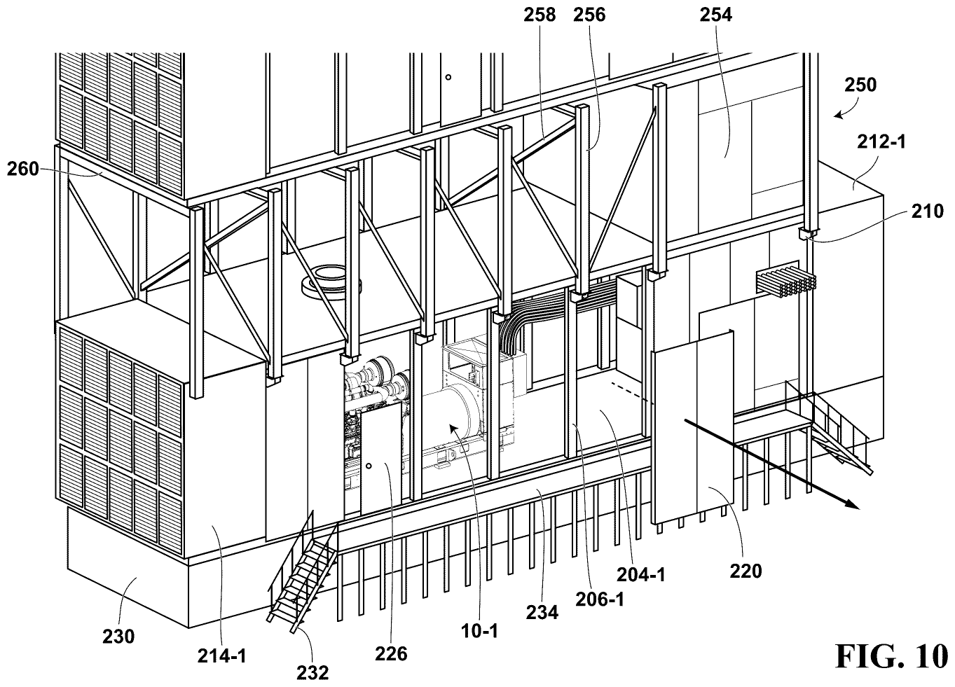

FIG. 10 shows an enlarged view of part of the structure shown in FIG. 9 to illustrate the frame structure of the modular enclosure 202-1 with removable exterior sidewall panels 220. The sidewall panels 220 are removably attached to vertical support members 206 of the skeletal frame of the first enclosure 202-1, using fasteners such as bolts or latches, so that the sidewall panel can be removed for access to equipment within the enclosure. For example, the removable modular sidewall panels, may be provided with various thicknesses, e.g. 2 inch or 6 inch. The side wall panels are mounted on the exterior of the skeletal frame to maximize uscable interior space. They are designed to removable during maintenance, e.g. bolted or latched to the skeletal frame, instead of welded. The removable sidewall panels and the roof assembly may comprise one or both of thermal insulation and acoustic insulation.

Since enclosures 202-1 and 202-2 are walk-in enclosures, as illustrated in FIG. 8, FIG. 9, and FIG. 10, some of the sidewall panels comprise an access door 226. For example, to access the first enclosure 202-1, a walkway 234 with railing and staircase 232 is provided. Fixed or movable staircases (not shown) may be provided to access the second enclosure 202-1, the space 252 within the stacking superstructure 250, and the enclosed space 254 within the stacking superstructure 250. Walk-in enclosures must also comply with applicable workplace safety standards, for example: with respect to clearances; avoidance of trip hazards; electrical safety standards, e.g. a neutral ground return (NGR); separation between fuel sources and electrical switching equipment to reduce fire risk; fire suppression systems; et al.

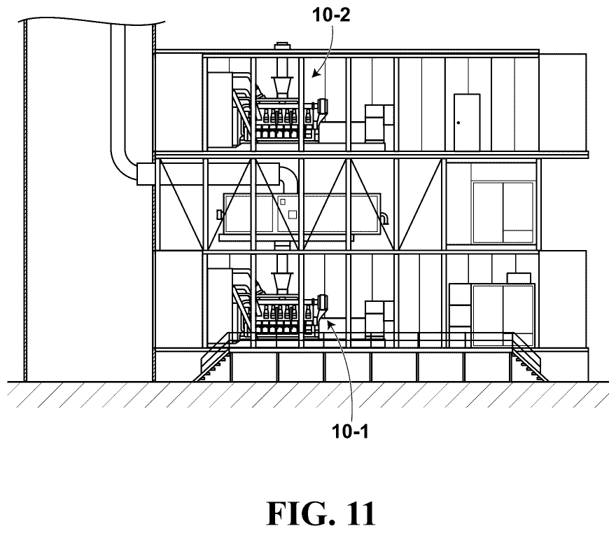

FIG. 11 is a schematic a side elevation view of part of the modular enclosure system of the second embodiment, with some of the side wall panels omitted to show the skeletal frame structure of the first and second enclosures, and the placement of the lower and upper generators 10-1 and 10-2.

The modular structure of the enclosures and the stacking superstructure of example embodiments, comprising a skeletal frame with a multilevel structure, and removable sidewall panels, and removable endwall panels comprising sound attenuation boxes, is customizable and scalable for stacking of at least two industrial generator sets, having a range of different sizes and power outputs. The modular enclosure structure with removable sidewall panels and endwall panels, which are removably attached to external surfaces of the skeletal frame allows for quick removal of panels for access to equipment for maintenance, and quick replacement, to reduce maintenance service turnaround. The usable space within the enclosures and within the stacking structure is increased by attaching the removable panels to the exterior of the skeletal frame. The modular construction allows for reconfiguration, e.g. adding, removing or moving an access door, enclosing part of the space within the stacking structure to create an equipment room, or to change the size of an equipment room.

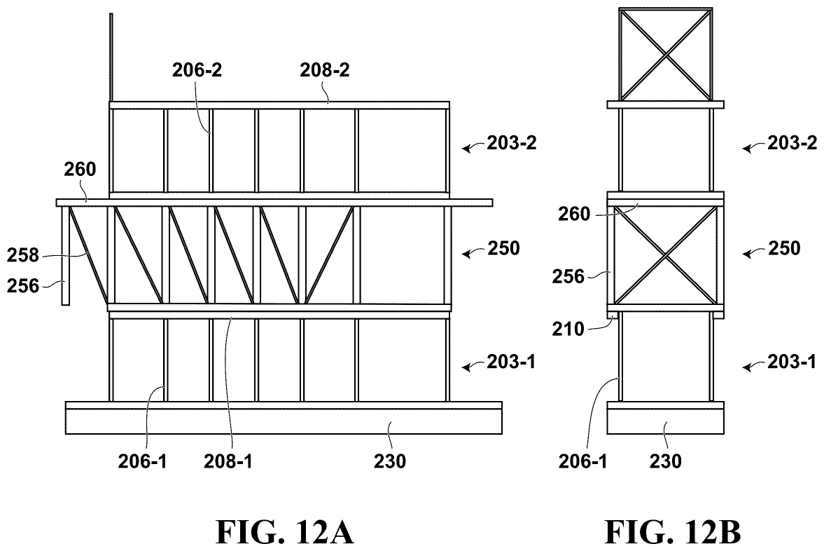

FIG. 12A and FIG. 12B, respectively, show a schematic simplified side-view and a simplified schematic end-view of components of a skeletal frame of a modular enclosure system, mounted on a base fuel tank 230. The skeletal frame of the modular enclosure system for a double-stack arrangement comprises a lower enclosure frame 203-1, a stacking superstructure 250, and an upper enclosure frame 203-2. The stacking superstructure 250 (Level 2) is engineered to support the upper enclosure (Level 3) comprising the upper enclosure frame 203-2, sidewall panels, sound attenuation boxes, roof structure and generator equipment within the upper enclosure, and its exhaust system. The lower enclosure frame 203-1 (Level 1) is engineered to support both the stacking superstructure 250 (Level 2), including any equipment or components within the stacking superstructure and the upper enclosure (Level 3) comprising the upper generator equipment, and the upper enclosure and its equipment. The Level 4 frame is provided simply to support the exhaust pipe from the exhaust system of the upper generator (e.g. as shown in FIG. 9). Each of the upper and lower enclosure frames 203-1 and 203-2 comprise a plurality of vertical support members 206-1 and 206-2, which support respective roof assemblies 208-1 and 208-2. The base of the lower enclosure frame 203-1 is mounted on the base fuel tank 230, or may be integral with the base fuel tank 230. The stacking superstructure 250 comprises a plurality of vertical support members 256, and cross-bracing members 258, and horizontal members 260. For example, as illustrated in FIG. 10, the vertical support members 256 of the stacking superstructure 250 are supported by lateral extensions 210 of the vertical members 206-1 of the frame structure 203-1 of the first (lower) enclosure 202-1; the second (upper) enclosure 202-2 is supported by the horizontal members 260 of the stacking superstructure 250.

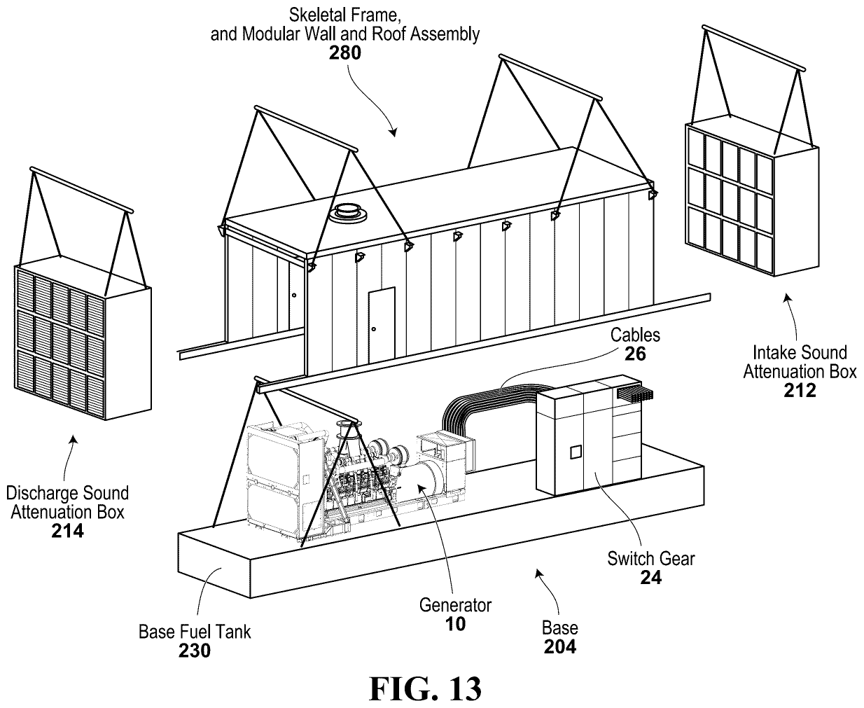

FIG. 13 is a schematic view showing disassembled components of a modular enclosure of the second embodiment, wherein the sound attenuation boxes 212-1 and 214-1 are removed from endwalls of the skeletal frame, and the skeletal frame, sidewalls and roof assembly are removed from the base 204 and base fuel tank 230 as a unit 280, e.g., to access the generator and associated equipment, or to separate the components for shipping. For example, the base unit assembly comprises the enclosure base 204 and the base fuel tank 230, and the generator 10, switch gear 24 and cables 26 are mounted on the base 204 for shipping. Since the sound attenuation boxes are modular, and can be provided with different levels of sound attenuation, they may be switched out to provide different levels of sound attenuation to meet local by-law requirements. For a single enclosure installation, the modular construction of the enclosure allows for the enclosure to be disassembled as shown in FIG. 13 for access to the generator and associated equipment for maintenance or replacement.

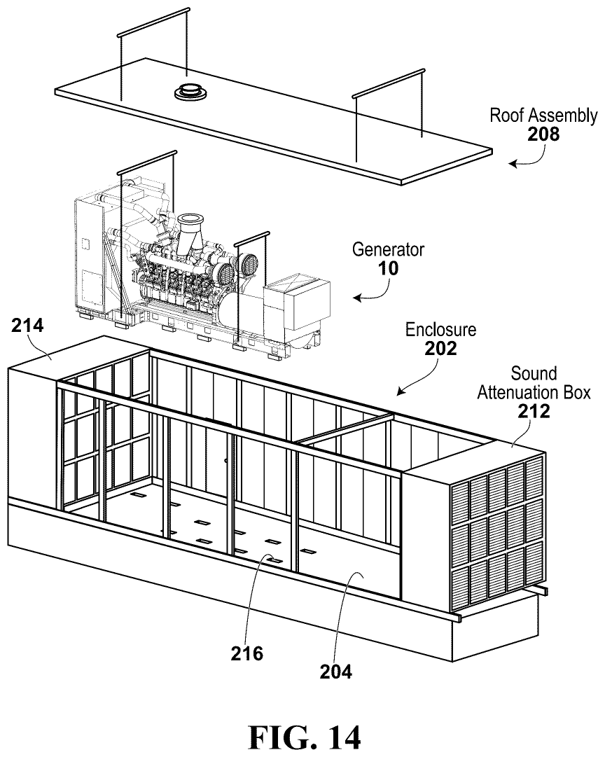

FIG. 14 is a schematic view showing a modular enclosure of a third embodiment wherein the enclosure roof assembly 208 is removable from the frame of the second (upper) enclosure 202 for access to lift-out or replace the generator 10. For example, a removable roof assembly may be provided to facilitate access to the generator, and/or other equipment, in the upper enclosure of a double stack modular enclosure system, or in a single enclosure installation. FIG. 14 illustrates schematically how the roof assembly 208 can be lifted off by crane to provide access for lifting out the generator 10 after it is unfastened from mounting pads 216 in the base 204 of the enclosure 202. Since the roof assembly 208 is removable the sound attenuation boxes 212 and 214 may be left in place during removal or installation of the generator.

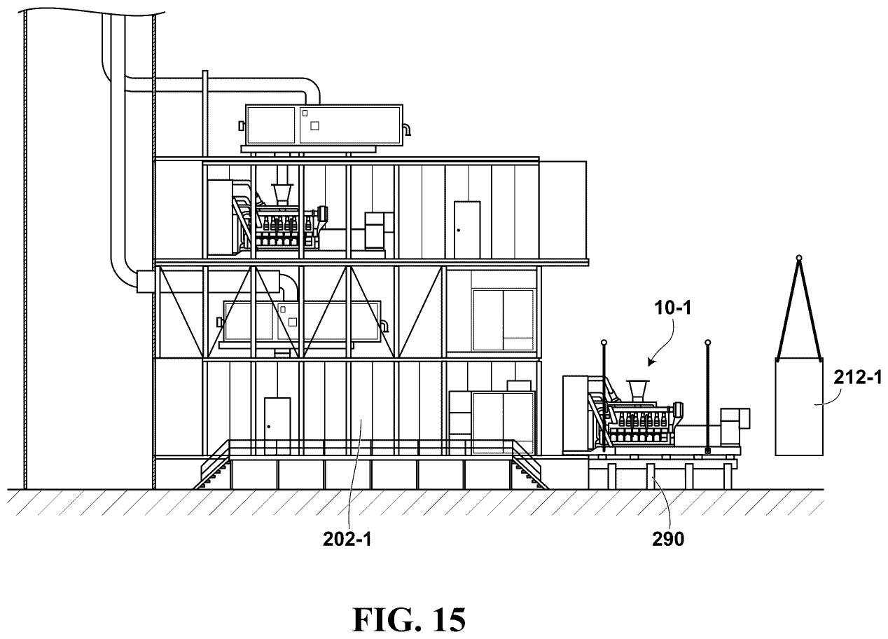

FIG. 15 is a schematic view showing a side view of a double stack modular enclosure system of a fourth embodiment, wherein the generator in the first (lower) enclosure 202-1 is mounted on a rail system 290 to enable the generator 10-1 to be removed and replaced for service or swap-out. To remove the generator 10-1, the intake sound attenuation box 212-1 is unfastened and lifted away from the intake end of the enclosure 202-1. Any other equipment, such as switch gear, can also be removed through the open end of the enclosure. A removable rail system 290 is positioned at the end of the enclosure 202-1 to enable the generator 10-1 to be pulled out through the end of the enclosure, and then lifted by crane.

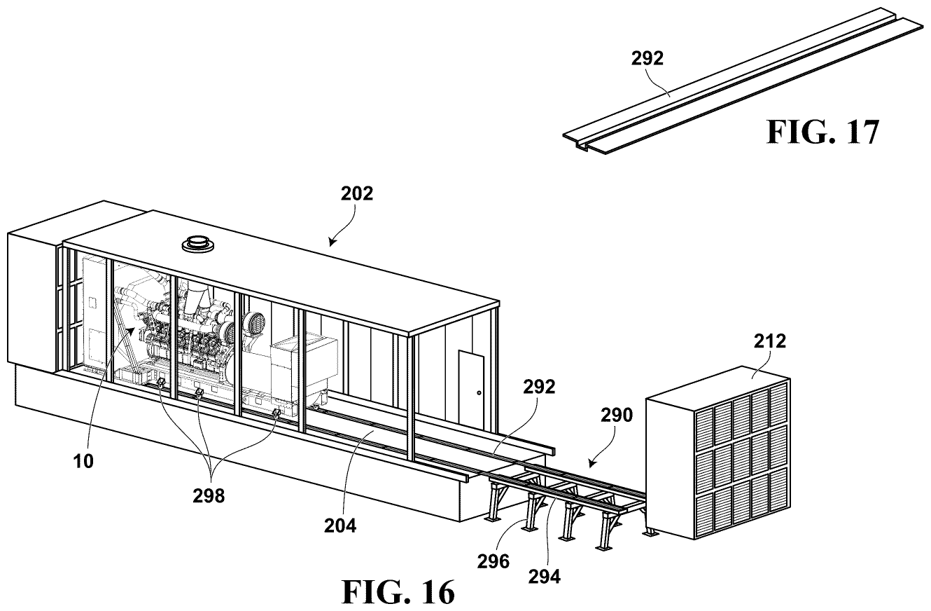

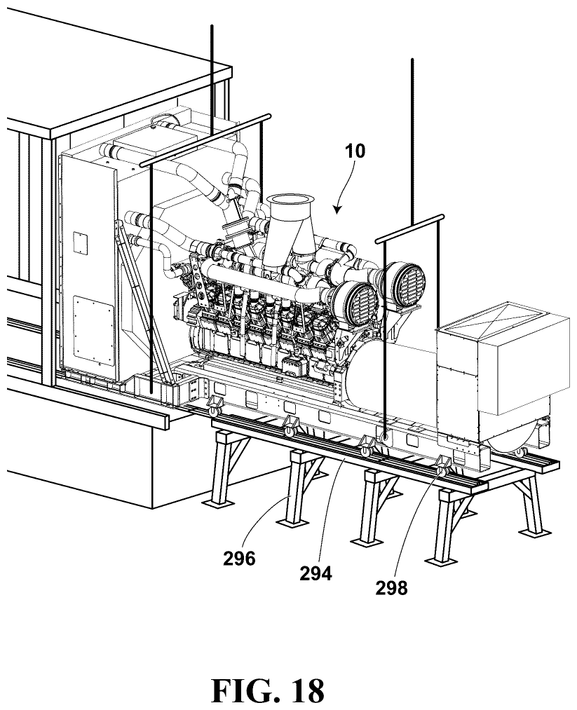

FIG. 16 is a schematic isometric view a modular enclosure of a fifth embodiment, wherein the generator is mounted on a rail system to enable the generator to be removed and replaced for service or swap-out. The wall panels of one side of the enclosure 202 are omitted to show the internal structure, in which a pair of rails 292 are inserted in the base 204 of the enclosure 202. An example rail unit 292 is shown in FIG. 17. The rails 292 are inserted into slots in the base 204. For example, the generator 10 is unfastened from its mounting pads, and jacked up to insert a set of wheels 298, or rollers, casters, a sled, truck, or other rolling means to move the generator along the rails. One or more rail units are inserted into the slots or recesses in the base 204, to provide a pair of rails extending from the open end of the base and underneath the generator. The generator is then lowered to engage the wheels on the rails. Part of the rail system 290, comprising external rails portions 294 and supports 296 extends beyond the end of the enclosure so that the generator can be winched out of the enclosure onto the external rail portions 294, from where it can then be lifted off the rails by crane. FIG. 18 is a schematic isometric view of part of the modular enclosure system shown in FIG. 16, wherein the generator 10 is supported on wheels 298 on part of the rail system 290 comprising support members 296 and rail units 294 extending out from the enclosure.

The rail removal process is reversed to replace or swap-out the generator. After the generator is repositioned over its mounting pads, and jacked up off the rails, the rails can be removed from the slots. Providing removable rails facilitates removal and replacement of the generator, while avoiding a potential tripping hazard which would be presented by permanent rails provided within the enclosure. The removal rails can be provided as modular rail units. The rail system allows for removal and replacement of the generator in enclosures where it is not feasible to have a removable roof structure, e.g. the first (lower) enclosure of a double-stack modular enclosure systems as described herein. Optionally, a similar rail system could be used for the second (upper) enclosure of a double-stack modular enclosure system.

In principle, it is envisaged that a multi-stack modular enclosure system comprising more than two generator enclosures may be feasible, e.g. a stack of three generator enclosures, with a first stacking superstructure between first and second generator enclosures and a second stacking superstructure between second and third generator enclosures. In practice, a multi-stack arrangement with more than two generator enclosures requires the lower levels to be engineered to support the additional weight of the overlying structures, and the additional height makes walk-in access to the upper levels more challenging. Also, the fuel system may require additional fuel pumps and day fuel tanks to supply fuel to the third generator. There is a trade-off between the cost of adding a third generator enclosure in a stacked configuration, vs. additional real-estate cost of a side-by-side installation.

The modular construction of the enclosures of example embodiments as described herein provides for at least one of the following features:

Modular wall panels can be provided with various thicknesses, e.g. 2 inch or 6 inch, which are removably mounted on an exterior of the skeletal frame; the wall panels are designed to be removable for maintenance (e.g. bolted or latched, instead of welded in place); external mounting of the wall panels maximizes useable interior space within the enclosure; wall panels may comprise thermal and/or acoustic insulation.

A removable roof panel, or roof assembly, allows the generator and/or other equipment to be lifted in and out by crane for maintenance or swap-out.

The sound attenuation boxes on each end of the generator enclosures are removable modules; they can be selected or replaced with modules having different levels of sound attenuation based on local sound bylaws. For example, local bylaw requirements may specify permissible sound levels, e.g. 65 dB at 7 metres, or 85 dB at 7 metres.

The fuel system may comprise an integrated fuel tank or a separate fuel tank. The main fuel tank may be a base fuel tank. For a double-stack modular enclosure system, the base fuel tank is sized to supply both the upper and lower generators, e.g. a base fuel tank which is 4 ft to 5 ft high. A day tank may be provided to assist with start-up for the upper generator; for example, a day tank with a capacity sized for e.g. 24 hr or 48 hr run-time may be provided within the stacking superstructure, to avoid having to pump fuel directly from the base fuel tank at start-up.

The exhaust system for each generator can be a simple muffler (silencer) or some type of exhaust filtration and treatment system, such as, an SCR (Selective Catalytic Reduction) unit which removes NOx, depending on the fuel source (natural gas or diesel) and on environmental requirements at site.

Removable wall panels comprising walk-in access doors, and fixed or movable staircases and walkways can be configured for access to upper and lower enclosures, and the space in the stacking superstructure, as appropriate.

In modular enclosure systems of other embodiments and variants, one or more of these features may be combined in various configurations.

Modular enclosure systems of example embodiments described herein are configured as walk-in enclosures, and as such, would be configured to meet relevant occupational health and safety regulations.

For other applications, it is envisaged that the enclosures of other embodiments may be configured as skin-fit enclosures having a skeletal frame with removable wall panels, removable end panels comprising sound attenuation boxes, and optionally a removable roof assembly, to provide access for maintenance or swap-out of the generator and associated equipment.

Although example embodiments have been described and illustrated in detail, it is to be clearly understood that the same is by way of illustration and example only and not to be taken by way of limitation, the scope of the present invention being limited only by the appended claims.

1. A modular enclosure system for industrial generator sets comprising:
a first enclosure for a first generator set;
a second enclosure for a second generator set;
a stacking superstructure;
the stacking superstructure being supported on the first enclosure and the second enclosure being supported on the stacking superstructure; and
the stacking superstructure providing vertical separation between the first and second enclosures comprising space for access and equipment.

2. A modular enclosure system for industrial generator sets comprising:
a first enclosure comprising a first skeletal frame for a first generator set;
a second enclosure comprising a second skeletal frame for a second generator set;
a stacking superstructure;
the stacking superstructure being supported on the first skeletal frame and the second skeletal frame being supported on the stacking superstructure; and
the stacking superstructure having a skeletal frame providing vertical separation between the first and second enclosures comprising space for access and equipment.

3. The modular enclosure system of claim 2, wherein part of the skeletal frame of the stacking superstructure is unenclosed to provide space for an exhaust system of the first generator set.

4. The modular enclosure system of claim 2, wherein part of the skeletal frame of the stacking superstructure is enclosed to provide an equipment enclosure.

5. The modular enclosure system of claim 2, wherein:
the first enclosure is modular comprising a base, supporting the first skeletal frame, and modular sidewall panels removably attached to side supports of the first skeletal frame, end panels comprising sound attenuation boxes removably attached to end supports of the first skeletal frame, and a roof assembly supported by the first skeletal frame; and
the second enclosure is modular comprising a base, supporting the second skeletal frame, and modular sidewall panels removably attached to side supports of the second skeletal frame, end panels comprising sound attenuation boxes removably attached to end supports of the second skeletal frame; and a roof assembly supported by the second skeletal frame.

6. The modular enclosure system of claim 5, wherein at least one of the removable sidewall panels comprises an access door.

7. The modular enclosure system of claim 5, wherein the removable sidewall panels and endwall panels are attached externally to surfaces of the first skeletal frame and the second skeletal frames.

8. The modular enclosure system of claim 5, wherein the removable sidewall panels and endwall panels are mounted externally to surfaces of the first and second skeletal frame and secured by bolts, latches, or other releasable fasteners.

9. The modular enclosure system of claim 5, wherein the removable sidewall panels comprise at least one of thermal insulation and acoustic insulation.

10. The modular enclosure system of claim 5, wherein the base of each of the first and second enclosures comprises mounting pads for the respective generator set.

11. The modular enclosure system of claim 5, wherein a roof assembly of the second enclosure is removable for installation or removal of the second generator set by lifting.

12. The modular enclosure system of claim 5, wherein the base of the first enclosure is mounted on a base fuel tank.

13. The modular enclosure system of claim 5, wherein the base of the first enclosure is part of a base fuel tank.

14. The modular enclosure system of claim 2, comprising walk-in access doors to the first and second enclosures.

15. The modular enclosure system of claim 2, comprising walk-in access doors to the first and second enclosures, and at least one of fixed and movable staircases to access the walk-in access doors and the space within the stacking superstructure.

16. The modular enclosure system of claim 2, wherein each of the first and second enclosures are configured for longitudinal airflow from an air intake through a sound attenuation box at one end of the enclosure and an air discharge through a sound attenuation box at an opposite end of the enclosure.

17. The modular enclosure system of claim 2, wherein each of the first and second enclosures are configured for longitudinal airflow from an air intake through a sound attenuation box at one end of the enclosure and an air discharge through a sound attenuation box at an opposite end of the enclosure, and comprising a discharge tower for receiving said air discharge from the first and second enclosures, and venting said air discharge at a top of the discharge tower.

18. The modular enclosure system of claim 2, wherein a base of the first enclosure comprises means for accepting a removable rail system for rail mounting of the first generator set

19. The modular enclosure system of claim 2, wherein a base of the second enclosure comprises means for accepting a removable rail system for rail mounting of the second generator set.

20. The modular enclosure system of claim 2, wherein part of the skeletal frame of the stacking superstructure is unenclosed to provide space for an exhaust system of the first generator set; and part of the skeletal frame of the stacking superstructure is enclosed to provide an equipment enclosure.

21. The modular enclosure system of claim 2, wherein: the first enclosure is modular comprising a base, supporting the first skeletal frame, and modular sidewall panels removably attached to side supports of the first skeletal frame, end panels comprising sound attenuation boxes removably attached to end supports of the first skeletal frame, and a roof assembly supported by the first skeletal frame; and the second enclosure is modular comprising a base, supporting the second skeletal frame, and modular sidewall panels removably attached to side supports of the second skeletal frame, end panels comprising sound attenuation boxes removably attached to end supports of the second skeletal frame; and a roof assembly supported by the second skeletal frame; and two or more of the following features:
a) wherein at least one of the removable sidewall panels comprises an access door;
b) wherein the removable sidewall panels and end wall panels are attached to external surfaces of the first skeletal frame and the second skeletal frames;
c) wherein the removable sidewall panels and end wall panels are secured to external surfaces of the first and second skeletal frame by bolts, latches, or other releasable fasteners;
d) wherein the removable sidewall panels comprise at least one of thermal insulation and acoustic insulation;
e) wherein the base of each of the first and second enclosures comprises mounting pads for the respective generator set;
f) wherein a roof assembly of the second enclosure is removable for installation or removal of the second generator set by lifting;
g) wherein the base of the first enclosure is mounted on a base fuel tank;
h) wherein the base of the first enclosure is part of a base fuel tank;
j) comprising walk-in access doors to the first and second enclosures; and
k) comprising walk-in access doors to the first and second enclosures, and at least one of fixed and movable staircases to access the walk-in access doors and the space within the stacking superstructure.

22. A modular enclosure system for industrial generators comprising:
a first enclosure comprising a first skeletal frame and housing a first generator set;
a second enclosure comprising a second skeletal frame and housing a second generator set;
a stacking superstructure;
the stacking superstructure being supported on the first skeletal frame and the second skeletal frame being supported on the stacking superstructure;
the stacking superstructure having a skeletal frame providing vertical separation between the first and second enclosures comprising a space for access and equipment;
a first exhaust system of the first generator set being mounted on the first enclosure in said space provided by the stacking superstructure; and a second exhaust system of the second generator set being mounted on the second enclosure.

23. The modular enclosure system of claim 22, wherein an exhaust pipe of the first exhaust system is routed longitudinally through the stacking superstructure.

24. The modular enclosure system of claim 22, wherein the first exhaust system is mounted within part of the stacking superstructure that is unenclosed, and an exhaust pipe the first exhaust system is routed longitudinally through the stacking superstructure.

25. The modular enclosure system of claim 22, wherein part of the stacking superstructure is enclosed by modular sidewall panels to provide an equipment enclosure.

26. The modular enclosure system of claim 22, wherein the first and second exhaust systems each comprise a Selective Catalytic Reduction system.

27. The modular enclosure system of claim 22, wherein the first and second exhaust systems each comprise a muffler.

28. The modular enclosure system of claim 22, wherein:
the first enclosure is modular comprising a base, supporting the first skeletal frame, and modular sidewall panels removably attached to side supports of the first skeletal frame, end panels comprising sound attenuation boxes removably attached to end supports of the first skeletal frame, and a roof assembly supported by the first skeletal frame; and
the second enclosure is modular comprising a base, supporting the second skeletal frame, and modular sidewall panels removably attached to side supports of the second skeletal frame, end panels comprising sound attenuation boxes removably attached to end supports of the second skeletal frame; and a roof assembly supported by the second skeletal frame.

29. The modular enclosure system of claim 28, wherein at least one of the removable sidewall panels comprises an access door.

30. The modular enclosure system of claim 28, wherein the removable sidewall panels and endwall panels are attached to external surfaces of the first and second skeletal frame.

31. The modular enclosure system of claim 28, wherein the removable sidewall panels and endwall panels are secured to external surfaces of the first skeletal frame and second skeletal frame by bolts, latches or other releasable fasteners.

32. The modular enclosure system of claim 28, wherein the removable sidewall panels comprise at least one of thermal insulation and acoustic insulation.

33. The modular enclosure system of claim 28, wherein the base of each of the first and second enclosures comprises mounting pads, the respective generator set being mounted on the mounting pads.

34. The modular enclosure system of claim 22, wherein a roof assembly of the second enclosure is removable for installation or removal of the second generator.

35. The modular enclosure system of claim 22, wherein a base of the first enclosure is mounted on a base fuel tank.

36. The modular enclosure system of claim 22, wherein a base of the first enclosure is part of a base fuel tank.

37. The modular enclosure system of claim 22, wherein a day tank for fuel for the second generator is mounted within the space of the stacking superstructure.

38. The modular enclosure system of claim 22, wherein a day tank for fuel for the second generator is mounted within the second enclosure.

39. The modular enclosure system of claim 22, wherein part of the stacking superstructure is enclosed by modular sidewall panels to provide an equipment enclosure, and switch gear of the second generator set is enclosed within said equipment enclosure.

40. The modular enclosure system of claim 22, comprising walk-in access doors to the first and second enclosures.

41. The modular enclosure system of claim 22, comprising walk-in access doors to the first and second enclosures, and comprising fixed or mobile staircases for accessing the walk-in access doors and the space within the stacking superstructure.

42. The modular enclosure system of claim 22, wherein: the first enclosure is sized to accommodate the first generator set and associated switch gear; and the second enclosure is sized to accommodate the first generator set and associated switch gear.

43. The modular enclosure system of claim 22, wherein the first and second enclosures are configured for longitudinal airflow from an air intake through a sound attenuation box at one end of the enclosure and an air discharge through a sound attenuation box at an opposite end of the enclosure.

44. The modular enclosure system of claim 22, wherein each of the first and second enclosures are configured for longitudinal airflow from an air intake through a sound attenuation box at one end of the enclosure and an air discharge through a sound attenuation box at an opposite end of the enclosure, and comprising a discharge tower for receiving said air discharge from the first and second enclosures, and venting said air discharge at a top of the discharge tower.

45. The modular enclosure system of claim 44, wherein exhaust pipes from each of the first and second exhaust systems are routed longitudinally into and through a discharge tower and vent at a top of the discharge tower.

46. The modular enclosure system of claim 28, wherein the base of the first enclosure comprises means for receiving a removable rail system for slidable installation or removal of the first generator set from an end of the first enclosure.

47. The modular enclosure system of claim 46, wherein the removable rail system comprises a plurality of rail units, and the means for receiving the removable rail system comprises one of slots, recesses, and other types of rail mountings for mounting the rail units.

48. The modular enclosure system of claim 47, wherein the removable rail system comprises a rail extension and support module that extends beyond the end of the first enclosure, the rail extension and support module having a length that accommodates the first generator outside the first enclosure.

49. The modular enclosure system of claim 47, wherein the rail units are modular lengths of rail, and a pair of slots is provided in the base to receive a pair of rails comprising the modular lengths of rail.

50. The modular enclosure system of claim 49, wherein the removable rail system comprises rolling means supporting the first generator on the pair of rails.

51. The modular enclosure system of claim 28, wherein the base of the second enclosure comprises means for receiving a removable rail system for slidable installation or removal of the second generator set from an end of the second enclosure.
